(19) United States
(12) Patent Application Publication
(10) Pub. No.: US 2007/0297045 A1
(43) Pub. Date: Dec. 27, 2007

(54) Light-Emitting Planar Body-Structured Body

(75) Inventors: Mieko Sakai, Tokyo (JP); Kenichiro Shinomiya, Yokohama-shi (JP); Kenichiro Saito, Kisarazu-shi (JP); Yukihiko Inoue, Kashiwa-shi (JP)

Correspondence Address: WENDEROTH, LIND & PONACK, L.L.P., 2033 K STREET N. W., SUITE 800, WASHINGTON, DC, 20006-1021, US

(73) Assignee: AVAILVS CORPORATION, CHIYODA-KU, TOKYO (JP)

(21) Appl. No.: 10/555,003

(22) PCT Filed: Apr. 30, 2004
(86) PCT No.: PCT/JP04/06291

§ 371 Date: Jun. 5, 2007

(30) Foreign Application Priority Data
May 2, 2003 (JP) 2003-126860

(51) Int. Cl. G02B 27/00

(52) U.S. Cl. 359/350

(57) ABSTRACT

A light-emitting planar body-structured body characterized in that it comprises an LED (light-emitting diode) light source which radiates ultraviolet radiation or near ultraviolet radiation and a planar body provided disposed in front thereof, and that the planar body is a light-transmitting resin molding containing dispersed therein at least one type of phosphors and light-storing bodies together with light-transmitting inorganic particles.

### TECHNICAL FIELD

The invention of this application relates to a light-emitting planar body-structured body. In further detail, the invention of the application relates to a thin-type novel light-emitting planar body-structured body, which utilizes a self-luminous system using ultra-violet emitting light source, whose light source is not visible from the outside and which is capable of efficiently emitting planar light, and which is yet capable of emitting light even after stopping light irradiation from the light source.

### BACKGROUND ART

There have been known heretofore light-emitting planar body structures which provide planar light emission from light-emitting bodies or light-storing bodies that are incorporated in transparent bodies made of resins, glasses, etc., by irradiating ultraviolet radiation using a phosphorescent light which emits ultraviolet radiation (black light), and they have been applied to various types of signs, advertisement panels, guiding plates, etc.

Most of the light-emitting planar body structures using conventional black light irradiation above employ an external illumination system; that is, they employ the system of emitting light on the side at which the black light for irradiating the ultraviolet radiation to the phosphor or to the light-storing body is installed. However, in case of using such an external illumination system, the presence of the black light used as the light source is visible, and because of the limitations concerning the arrangement of the black light, the application of the light-emitting body has been considerably restricted.

Under such circumstances, recently studied are those of the self-luminous type, in which the light source is provided disposed opposite to the light emitting and illuminating side of the light source; that is, the light source is located on the back side of the light-emitting planar body, and various types of such light-emitting planar bodies are proposed to the present. For instance, there is proposed a self-luminous type sight line guiding mark (reference 1), which uses phosphorescent dye incorporated in a transparent synthetic resin, to which ultraviolet radiation is irradiated using a UV lamp (black light), and the like.

However, in the case of this self-luminous type, for instance, as shown in FIG. 4, in general, a phosphorescent light tube (1) (black light) having an outer diameter of 16 mm or longer is used. Thus, even in case a reflector plate (2) should be provided, certain distance was necessary to realize uniform planar light emission from the light-emitting planar body (3). That is, at least a thickness (L) of 100 mm or longer was necessary. Accordingly, the resulting light-emitting planar body structure had to be thick. Furthermore, in the case of self-luminous type, the design was not appraisable because the base material of the light-emitting planar body was transparent and the presence of the black light provided at the back of the light-emitting planar body was externally visualized. Due to these reasons, the application of self-luminous type light-emitting planar body structures using black light was greatly restricted.

Accordingly, in order to obtain a thinner and more compact structure, there is proposed to use a light-emitting diode as the light source. For instance, there is proposed to constitute a light-emitting device (reference 2) using a light-emitting planar body comprising phosphor bodies dispersed in a silicone body combined with a light-emitting diode, or to constitute a self-luminous type structure (reference 3) using a GaN semiconductor laser as the light source, in which a light-emitting planar body comprising phosphor bodies dispersed in a resin or a glass is irradiated by ultra-violet radiation for light emission.

Surely, because a light-emitting diode is a light source far smaller than a black light, it is possible to implement a thin light-emitting planar body structure in case such a light-emitting diode is used. However, on the other hand, because a light-emitting diode has strong directivity, using few light sources results in a structure with a strong tendency of point light emission with smaller light emission area as compared with such having planar light emission; accordingly, such a structure causes a problem that a light-emitting planar body is not always easy to realize. Moreover, because the light-emitting planar body structures proposed heretofore employ light-emitting planar bodies using transparent base materials such as resins or glasses, the problem that the light-emitting diodes used as the light source are visible from the outside still remained unsolved.

Accordingly, the objective of the invention of the application is to overcome the aforementioned problems, and to provide a thinner novel light-emitting planar body-structured body, which utilizes a self-luminous system using ultra-violet emitting light source, which is capable of efficiently emitting light from a light-emitting planar body having larger area, and yet, whose light source is not discernible from the outside.

### REFERENCES

1: Japanese Patent No. 2001-26914
2: Japanese Patent No. 2000-208818
3: Japanese Patent No. 2000-174346

### DISCLOSURE OF INVENTION

The invention of the application provides, as a solution for the aforementioned problems, firstly, a light-emitting planar body-structured body characterized in that it comprises an LED (light-emitting diode) light source which radiates ultraviolet radiation or near ultraviolet radiation and a planar body provided in front thereof, and that the planar body is a light-transmitting resin molding containing dispersed therein at least one type of phosphors and light-storing bodies together with light-transmitting inorganic particles.

The invention provides, secondly, a light-emitting planar body-structured body characterized in that the planar body made of light-transmitting resin molding contains 30 wt % or less of at least one type of phosphors and light-storing bodies; thirdly, a light-emitting planar body-structured body characterized in that the planar body made of light-transmitting resin molding contains 10 wt % or more of light-transmitting inorganic particles; fourthly, a light-emitting planar body-structured body characterized in that the planar body made of resin molding contains a coloring pigment; fifthly, a light-emitting planar body-structured body characterized in that the light-transmitting inorganic particles contained in the planar body made of resin molding is constituted of small particle components each 180 μm to 9.5 mm in size and fine particle components each under 180 μm in size; and sixthly, a light-emitting planar body-structured body characterized in that the ratio by weight of the small particle component (W1) to the fine particle component (W2), W1/W2, is in the range of 1/5 to 8/1.

Further, the invention of the application provides, seventhly, a light-emitting planar body-structured body characterized by having a reflector body provided on at least one of the back and the side parts of the LED light source; eighthly, a light-emitting planar body-structured body characterized by having the LED light source embedded in and united with the planar body; ninthly, a light-emitting planar body-structured body characterized in that the light-transmitting resin molding having embedded therein the LED light source is provided in contact with the back plane of the planar body made of light-transmitting resin molding; tenthly, a light-emitting planar body-structured body characterized in that a thickness from the front to the back as measured from the surface of the planar body is not larger than 50 mm; and eleventhly, a light-emitting planar body-structured body characterized in that the LED light source is a light diffusion type ultraviolet LED.

In the invention of the application, as described above, because an LED (light-emitting diode) which radiates ultraviolet radiation or near ultraviolet radiation is used as the light source, and because the light-emitting planar body is a molding made of light-transmitting resin containing dispersed therein at least one type of phosphors and light-storing bodies together with light-transmitting inorganic particles, an efficient planar light emission with larger area is made possible by utilizing the light diffusing (scattering) function of the light-transmitting inorganic particles even in case smaller number of LEDs are arranged. Thus, the invention of the application provides an outstanding effect that the presence of the light source LED is not externally perceived.

Furthermore, in case light-storing bodies are incorporated, planar light-emission is still possible even after ultraviolet irradiation from LEDs is stopped.

### BRIEF DESCRIPTION OF THE DRAWINGS

FIG. 1 is a side cross sectional view showing an example of the embodiment of a light-emitting planar body-structured body of the invention of the application.

FIG. 2 is a side view (a) and a planar arrangement view (b) of LED light sources provided in a zigzag arrangement.

FIG. 3 is a side cross sectional view showing another example of the embodiment of the light-emitting planar body-structured body of the invention of the application.

FIG. 4 is a side cross sectional view showing an example of a conventional light-emitting planar body structure of self-luminous type using a black light.

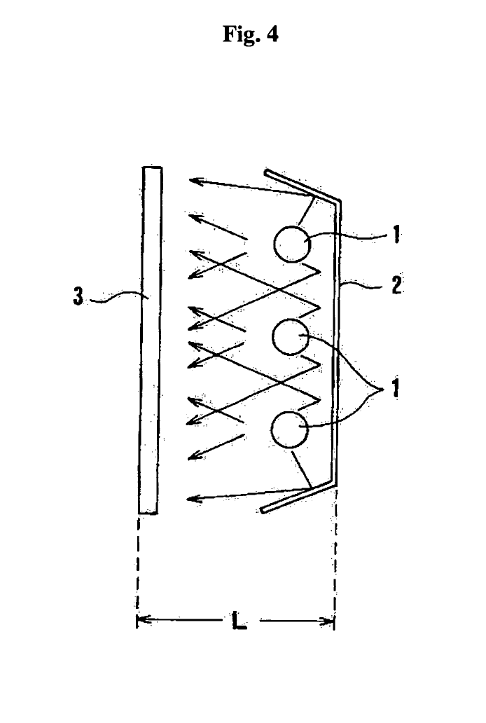

In the figures, the numerals stand for the followings:
1 Phosphorescent light tube (black light)
2 Reflecting plane
3 Light-emitting planar body
11 LED
12 Reflector plate
13 Light-emitting planar body
14 Resin molding

### BEST MODE FOR CARRYING OUT THE INVENTION

The invention of the application has the above characteristics, and the mode for carrying out the invention is described below.

Firstly, the constitution of the light-emitting planar body, which is the characteristic part of the invention of the application, is described. The phosphor that is included in the molding of the light-emitting planar body may be an inorganic compound or an organic compound; as inorganic compounds, there can be exemplified oxides, sulfides, and the like of metals such as aluminum, calcium, barium, magnesium, zinc, cadmium and strontium, having added therein heavy metals and rare earth oxides and the like such as europium, as activating agents. As organic compounds, usable are the so-called phosphorescent dyes. For instance, examples include fluorescein, rhodamin, eosine, pyramidine, naphthalimide, perylene, and the like.

One or more types of the phosphors above may be used as a mixture.

As light-storing bodies, usable are the metal oxides similar to above, for instance, strontium aluminate and the like, having added therein heavy metals and rare earth oxides and the like such as europium as an activating agent.

In case inorganic compounds are used as phosphors and light-storing bodies, the particle diameter thereof is generally under 180 μm (JIS standard, hereinafter the same), preferably, under 150 μm.

One or more types of phosphors and light-storing bodies may be blended as mixtures, depending on the objective and the usage of the light-emitting planar body.

The light-transmitting resin for use as the matrix material constituting the light-emitting planar body may be selected generally from various types, for instance, methacrylic resins such as polymethyl methacrylate (PMMA), polycarbonate resins, acrylic resins, styrene resins, silicone resins, polyester resins, and the like, depending on the objective and the usage of the light-emitting planar body, while taking various properties into consideration, such as lightfastness, water resistance, heat resistance, strength, wear resistance, moldability and translucency.

Further concerning the light-transmitting inorganic particles to be incorporated in the light-emitting planar body, usable are crushed quartz-based natural stones, glass powder, aluminum hydroxide, and the like. These may have specific color tones.

Preferably, the light-transmitting inorganic particles above consist of small particle components with particle diameter between 180 μm and 9.5 mm and of fine particle components with particle diameter under 180 μm. By setting groups differing in particle diameter in this manner, the strength of the light-emitting planar body can be effectively improved, and the effect of light diffusion (scattering) can be effectively increased.

In the case particles of inorganic compound are used for the phosphors and light-storing bodies, they may be used as a part or all of the fine particle components under 180 μm in size.

The weight ratio W1/W2 of the small particle components (W1) to fine particle components (W2) is preferably between 1/5 and 8/1.

By taking the basics and composition into consideration, the light-emitting planar body of the invention of the application is considered to contain phosphors and light-storing bodies (A), light-transmitting inorganic particles (W=W1+W2) (B), and a resin (C), at a weight ratio of, preferably, in general, 30 wt % or less of A, 10 wt % or more of B, and 7 to 60 wt % of C. More preferably, the light-emitting planar body contains 0.1 to 30 wt % of at least one of phosphors and light-storing bodies (A), and 10 to 92.9 wt % of light-transmitting inorganic particles (B). In case the ratio of resin (C) is reduced, the characteristics of the artificial stone material having a natural stone-like appearance becomes stressed.

Further, in addition to the light-transmitting inorganic particles above, the light-emitting planar body of the invention of the application may further contain as a part of the blended component, inorganic particles properly selected from minerals such as olivines, feldspars, pyroxenes and micas, naturally occurring stones such as granites and metamorphic rocks, ceramics, glass, metals, and the like.

The same applies to fine particle components. Various types of artificial and natural fine particle components can be mentioned. For instance, calcium carbonate, water, aluminum oxide, and the like are the readily available blending components.

Furthermore, there may be added in addition to the fine particle components above, various types of inorganic pigment components such as manganese dioxide, titanium dioxide, zirconium silicate and iron oxide to adjust the color tone; or components such as antimony trioxide, boron compounds and bromine compounds to impart flame-retardant properties.

In order to adjust the color tone, there may be added organic pigments or dyes such as those based on azo, and phthalocyanine to the resin component.

The light-emitting planar body of the invention of the application may be formed in various types of shapes such as planar, cylindrical, or curved, and waved, so long as they function as planar light-emitting bodies and are suitable for applications. Accordingly, molding can be made in various embodiments, and injection molding, compression molding, and the like may be carried out for shaping into plates, cylinders, and the like.

In case of compression molding, for example, the material (blended material), which is obtained in advance by blending the phosphors and light-storing bodies, the inorganic particles, and the resin component in amounts necessary at the completion of molding and kneading, is fed on the horizontal frame provided as the lower mold, the upper mold is then engaged, and compression molding is carried out by pressing under a planar pressure of 30 to 1000 N/cm². During compression, heating is applied in the temperature range of about 90 to 140° C. for about 5 to 20 minutes.

Further, in the above compression molding under heating, vibration may be applied together with pressure to the mold frame in order to improve fluidity of the mixed material above within the mold frame.

The molding method using compression molding as above is effective for mass production of moldings having relatively simple shapes, such as flat panel moldings, and is economically excellent because there is almost no material loss.

Furthermore, in the invention, the surface of the molding after shaping may be subjected to working, such that the small particle components of the inorganic particles described above may be exposed on the surface portion.

As the method for realizing the above, there may be first employed a selective removal method of the resin component. More specifically, for example, after releasing the molding from the mold, it is effective to eject high-pressure water to the surface of the molding to apply surface working.

The working above depends on the thickness, the distance between the molding and the nozzle, work shape, and the like, and although not limiting, in case of a molding 2 to 20 cm in thickness, in general, the water pressure may be set around 500 to 8000 N/cm² with a nozzle height of about 2 to 10 cm. This pressure is a water pressure condition lower than that for naturally occurring stones.

That is, the presence of resin component more easily enables working at higher quality.

There is no particular limitations concerning the nozzles and the system for ejecting high-pressure water, and various types are employable.

By the surface working above, there can be realized planarization or surface roughening using water jets, and thereby artificial stones having a rich and massive appearance can be produced.

The presence of resin prevents surface whitening from occurring, and facilitates the treatment of liquid wastes as compared with the case of employing etching method using chemicals.

As a matter of course, if necessary, the surface portion may be partly removed by treating with an organic solvent to soften or melt the resin component.

The organic solvent for use in the case above may be selected depending on the resin component used; for instance, there can be exemplified halogenated hydrocarbons such as ethylene chloride, methylene chloride and chloroform, carboxylic acids such as acetic anhydride, ethyl acetate and butyl acetate and ester compound thereof or acetone, tetrahydrofuran, DMF, DMSO, and the like.

The molding may be immersed into those organic solvents, or the organic solvents may be sprayed or flown down on the molding, and the softened or molten resin components are removed from the surface portion to form surface irregularities.

Otherwise, wire brushes, cutting means, and the like may be applied to the resin components, which are low in hardness, to thereby scratch them off from the surface portion to form the irregularities.

After surface roughening by any type of means above and applying surface working, the surface is polished as described above, to thereby partly break the coating layer on the surface of the small particle components, such that the coating layer and the cross section of the particles containing the small particle components should be exposed on the surface portion of the product. In this manner, surface massiveness having particular deepness and luster is realized. This is attributed to the reflection phenomena specific of light.

There are no particular restrictions concerning the means for surface polishing, and surface polishing can be carried out by using tools such as grinding stone, polishing cloth and polishing belt, or by using polishing agents such as buff polishers and rubbing compounds.

As polishers, properly used are those mainly exerting polishing function, such as diamond, boron carbide, corundum, alumina and zirconia, or those mainly exerting rounding function, such as rotten stone, dolomite, alumina, chromium oxide and cerium oxide.

As a matter of course, the surface portion may be subjected to further surface roughening to form irregularities after applying polishing.

Furthermore, in the light-emitting planar body according to the invention of the application, plural planar bodies above may be laminated, or may be laminated with a translucent resin plate, a glass sheet, and the like. Moreover, in general, the thickness of the light-emitting planar body above is preferably 40 mm or less, but practically preferred is 30 mm or less, and more preferred is about 1 to 10 mm. Those that are excessively thick weaken the light emission of the transmitted ultraviolet radiation, and are not preferable from the viewpoint of cost increase and the like.

Various types of LED (light-emitting diode) radiating ultraviolet radiation or near ultraviolet radiation may be considered; however, for instance, mentioned as preferred examples are GaN semiconductor lasers and LEDs of ultraviolet diffusion type.

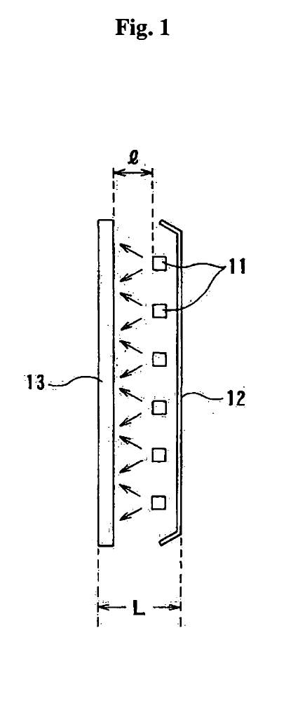

Further, as an example of a preferred embodiment of the light-emitting planar body-structured body according to the invention of the application, a reflector plate part is provided on at least one of the back and the side parts of the LED light source. In the structure, as exemplified in FIG. 1, the aforementioned LED (light-emitting diode) (11) as light source and light-emitting planar body (13) are the basic constituents, and in practice, a reflector plate (12) can be provided. Independent of whether the reflector plate (12) is provided or not, the thickness (L) from the front to the back of the entire structure as measured from surface of the light-emitting planar body (13) can be considerably reduced as compared with conventional ones; for instance, the thickness is 50 mm or less.

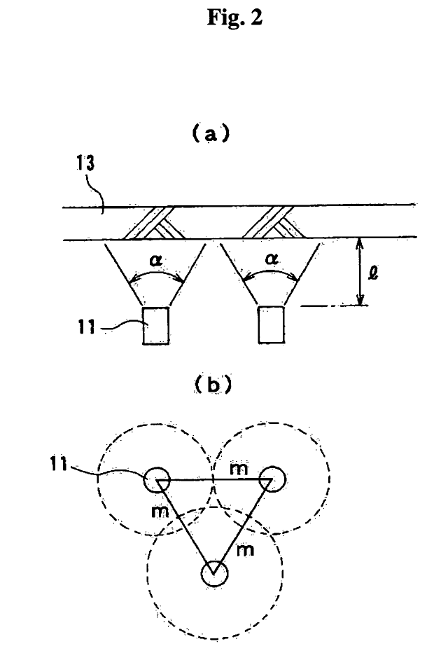

With respect to the area of the light-emitting planar body (13), the approximate number of the aforementioned LEDs (11) to be arranged can be determined by mainly considering the composition and the thickness of the light-emitting planar body (13), the type and the light-emitting and light-diffusing properties of the LED (11), and the distance (l) to the light-emitting planar body (13). Considering the number of the arranged LEDs (11) in a zigzag arrangement using light-diffusion type LEDs with a light-scattering angle (α) of 100°, for instance, as exemplified in FIG. 2, and should be l=30 mm, in general, uniform light emission can be obtained with m=60 mm. If l<25 mm, uneven light emission would occur, and similarly, uneven light emission tends to occur with m<50 mm.

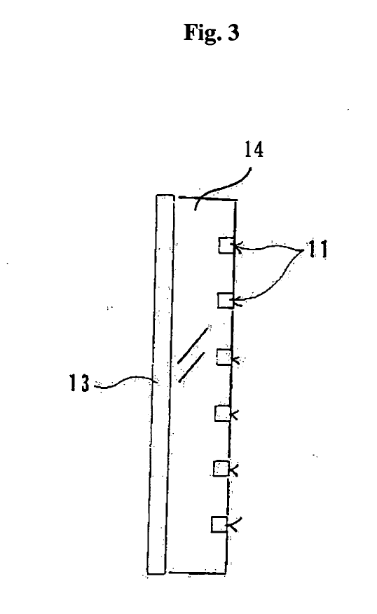

Further, in the invention of the application, a structure as shown in FIG. 3 can be exemplified as the embodiment. In the structure, a light-transmitting resin molding (14) having embedded therein an LED (11) light source is provided in contact with the back side of the light-emitting planar body (13) made of a light-transmitting resin molding having dispersed therein light-transmitting inorganic particles. In this structure, the installation of the LED (11) and the position can be stably maintained by the light-transmitting resin molding (14). In this structure, as a matter of course, an additional reflector plate (12) may be provided as in the example shown in FIG. 1.

For the light-transmitting resin molding (14) into which the LED (11) is embedded, usable is the same light-transmitting resin constituting the aforementioned light-emitting planar body (13), or a variety of resins similar to that and the like.

The invention of the application is described in further detail below by way of Examples below. It is needless to say that the invention is not restricted to the following examples.

### EXAMPLES

### Example 1

Two types of phosphorescent light-emitting planar body (3.0 mm in thickness), whose composition is shown in Table 1, were prepared, and were set in a zigzag arrangement as shown in FIG. 2 by using a diffusion type ultraviolet-emitting LED (NICHIA CORPORATION, NSHU:550: 5-mm diameter, light output 700 μW, diffusion angle 100°). In the arrangement, m=60 mm and l=30 mm. A reflector plate was used to give a total thickness of L=50 mm. The LED light source was not perceived at all from the front side of the light-emitting planar body.

Uniform light emission was obtained for both phosphorescent red light-emitting planar body and phosphorescent blue light-emitting planar body with excellent vision properties.

Luminance of red: 7 cd/m² and blue: 7 cd/m² was obtained.

TABLE 1

| | Amount blended (W %) | |
|---|---|---|
| | | Phosphorescent |
| | Phosphorescent | blue light- |
| | red light-emitting | emitting |
| | planar body | planar body |
| MMA | 18.00% | 19.00% |
| Peroxide-based hardening material | 0.40% | 0.40% |
| Transparent small particle | 58.00% | 58.00% |
| components (quartz) | | |
| Fine particle components | 21.10% | 17.70% |
| (aluminum hydroxide) | | |
| Phosphorescent red pigment | 2.40% | |
| Organic red pigment | 0.10% | |
| Phosphorescent blue pigment | | 2.40% |
| Copper oxide based blue pigment | | 2.50% |
| Total | 100% | 100% |

### Example 2

Light-storing light-emitting planar body (4.0 mm in thickness), whose composition is shown in Table 2, was prepared, and was set in a zigzag arrangement as shown in FIG. 2 by using the same light source as that used in Example 1. In the arrangement, m=50 mm and l=25 mm. No reflector plate was used. The total thickness L=45 mm.

Similar to Example 1, the LED light source was not perceived at all from the front side of the light-emitting planar body.

After irradiation for 60 minutes, the light source was switched off, and the time elapsed to yield a luminance of 3 mcd/m² was measured. The time thus obtained was 8.5 hours.

TABLE 2

| | Amount blended |
|---|---|
| | (W %) |
| | Light-storing (green) |
| | light-emitting |
| | planar body |
| MMA | 18.00% |
| Peroxide-based hardening material | 0.40% |
| Transparent small particle components (quartz) | 56.00% |
| Fine particle components (aluminum hydroxide) | 17.00% |
| Light-storing pigment (NEMOTO & CO., LTD.) | 8.60% |
| Total | 100% |

### Example 3

A structure body shown in FIG. 3 was prepared. The light-emitting planar body (13) with the composition shown in Table 1 in Example 1 was prepared at a thickness of 3 mm, and a light-transmitting resin molding (14) having embedded therein a 30 mm thick LED (11) light source was placed in contact with the back plane of the light-emitting planar body.

A diffusion type ultraviolet-emitting LED (NICHIA CORPORATION, NSHU:550: 5-mm diameter, light output 700 μW, diffusion angle 100°) was used as the LED (11) light source, and was buried in the resin molding (14) obtained by shaping transparent acrylic resin in such a longitudinal arrangement as that shown in FIG. 3 and a planar arrangement shown in FIG. 2, with m=30 mm.

On switching on the LED (11) light source, the presence of the LED (11) was not visible from the front side of the light-emitting planar body (13). Uniform light emission was obtained for both phosphorescent red light-emitting planar body and phosphorescent blue light-emitting planar body, with the luminance on light emission of red 15.5 cd/m² and blue 15.5 cd/m².

### INDUSTRIAL APPLICABILITY

As described in detail above, the invention of the application provides a thinner and novel light-emitting planar body-structured body, which is a light-emitting planar body structure of self-luminous type using ultra-violet emitting light source, capable of efficiently emitting light from a light-emitting planar body having larger area, and yet, whose light source is not discernible from the outside.

By using the invention of the application, there is realized a novel thin-type self-luminous type light-emitting body, which is thin and uniform, and which possesses high light-storing and phosphorescent light-emitting properties useful as, for instance, materials and installations and the like to be used in, for example, lines of zebra zones, center lines, guard rails, lines of runways in airports, traffic signs and emergency signs (inclusive of temporary signs), car stoppers, delineators, emergency evacuation guide signs, advertisements, various types of signs, ornaments of furniture, under construction light tubes, illuminations, counter tops, clearance lamps, and the like.

1. A light-emitting planar body-structured body characterized in that it comprises an LED (light-emitting diode) light source which radiates ultraviolet radiation or near ultraviolet radiation and a planar body provided in front thereof, and that the planar body is a light-transmitting resin molding containing dispersed therein at least one type of phosphors and light-storing bodies together with light-transmitting inorganic particles different in particle diameter that are blended and dispersed.

2. A light-emitting planar body-structured body of claim 1, characterized in that the planar body made of light-transmitting resin molding contains 30 wt % or less of at least one type of phosphors and light-storing bodies.

3. A light-emitting planar body-structured body of claim 1, characterized in that the planar body made of light-transmitting resin molding contains 10 wt % or more of light-transmitting inorganic particles.

4. A light-emitting planar body-structured body of claim 1, characterized in that the planar body made of resin molding contains a coloring pigment.

5. A light-emitting planar body-structured body of claim 1, characterized in that the light-transmitting inorganic particles different in particle diameter contained in the planar body made of resin molding is constituted of small particles components each 180 μm to 9.5 mm in size and fine particle components each under 180 μm in size.

6. A light-emitting planar body-structured body of claim 5, characterized in that the ratio by weight of the small particle component (W1) to the fine particle component (W2), W1/W2, is in the range of 1/5 to 8/1.

7. A light-emitting planar body-structured body of claim 1, characterized by having a reflector body provided on at least one of the back and the side parts of the LED light source.

8. A light-emitting planar body-structured body of claim 1, characterized by having the LED light source embedded in and united with the planar body.

9. A light-emitting planar body-structured body of claim 1, characterized in that the light-transmitting resin molding having embedded therein the LED light source is provided in contact with the back plane of the planar body made of light-transmitting resin molding.

10. A light-emitting planar body-structured body of claim 1, characterized in that a thickness from the front to the back as measured from the surface of the planar body is 50 mm or less.

11. A light-emitting planar body-structured body of claim 1, characterized in that the LED light source is a light diffusion type ultraviolet LED.

12. A light-emitting planar body-structured body of claim 2, characterized in that the planar body made of light-transmitting resin molding contains 10 wt % or more of light-transmitting inorganic particles.

13. A light-emitting planar body-structured body of claim 2, characterized in that the planar body made of resin molding contains a coloring pigment.

14. A light-emitting planar body-structured body of claim 3, characterized in that the planar body made of resin molding contains a coloring pigment.

15. A light-emitting planar body-structured body of claim 12, characterized in that the planar body made of resin molding contains a coloring pigment.

16. A light-emitting planar body-structured body of claim 2, characterized in that the light-transmitting inorganic particles different in particle diameter contained in the planar body made of resin molding is constituted of small particles components each 180 μm to 9.5 mm in size and fine particle components each under 180 μm in size.

17. A light-emitting planar body-structured body of claim 3, characterized in that the light-transmitting inorganic particles different in particle diameter contained in the planar body made of resin molding is constituted of small particles components each 180 μm to 9.5 mm in size and fine particle components each under 180 μm in size.

18. A light-emitting planar body-structured body of claim 12, characterized in that the light-transmitting inorganic particles different in particle diameter contained in the planar body made of resin molding is constituted of small particles components each 180 μm to 9.5 mm in size and fine particle components each under 180 μm in size.

19. A light-emitting planar body-structured body of claim 4, characterized in that the light-transmitting inorganic particles different in particle diameter contained in the planar body made of resin molding is constituted of small particles components each 180 μm to 9.5 mm in size and fine particle components each under 180 μm in size.

20. A light-emitting planar body-structured body of claim 13, characterized in that the light-transmitting inorganic particles different in particle diameter contained in the planar body made of resin molding is constituted of small particles components each 180 μm to 9.5 mm in size and fine particle components each under 180 μm in size.
